(19) United States
(12) Patent Application Publication
(10) Pub. No.: US 2026/0344905 A1
(43) Pub. Date: Nov. 5, 2026

(54) Resilent Unit and Method of Manufacture

(71) Applicant: HS Products Ltd., West Yorkshire (GB)

(72) Inventors: Darren MARCANGELO, West Yorkshire (GB); David CLARE, West Yorkshire (GB); Richard ESSERY, West Yorkshire (GB); Christopher BALMER, West Yorkshire (GB); Steaven HODGSON, West Yorkshire (GB)

(73) Assignee: HS Products Ltd., West Yorkshire (GB)

(21) Appl. No.: 19/470,081

(22) PCT Filed: Mar. 28, 2024
(86) PCT No.: PCT/GB2024/050865

§ 371 Date: Sep. 29, 2025

(30) Foreign Application Priority Data
Mar. 31, 2023 (GB) 2304833.3

(51) Int. Cl. A47C 27/06; F16F 1/02

(52) U.S. Cl. CPC A47C 27/064; F16F 1/024; F16F 2226/04

(57) ABSTRACT

A resilient unit 1000 comprises two outer portions of spacer fabric 1100 and 1200 and a resilient core therebetween. The resilient core comprises an array of resilient elements which are in this example metallic coil springs S in 10 individual pockets P. The portions 1100 and 1200 of spacer fabric are joined together along the edges of the unit 1000, for example by ultrasonic welding at W, though other methods of joining the 15 portions 1100 and 1200 could be employed. (FIG. 1)

The present invention relates to a resilient unit, suitable for use as a stand-alone article or in an upholstered article, and to a method of manufacturing such a unit, and is concerned particularly with a resilient unit that includes a so-called “spacer fabric” material, and to a method of manufacturing such a unit.

Spacer fabrics typically comprise two knitted layers and spacer, or pile, threads that connect the two layers whilst at the same time separating them and keeping them apart.

Embodiments of the present invention aim to provide a resilient unit that is comfortable to a user, air permeable and recyclable.

The present invention is defined in the attached independent claims, to which reference should now be made. Further, preferred features may be found in the sub-claims appended thereto.

According to one aspect of the present invention, there is provided a resilient unit comprising at least one outer portion, and a resilient core, wherein the outer portion comprises a spacer material including inner and outer layers linked by connecting pile threads, and wherein the outer portion is attached to the resilient core.

The outer portion may be arranged to extend around the core and may comprise edges that are joined together at a perimeter region of the unit.

Preferably, the outer portion comprises first and second outer portions joined at least at a perimeter region of the unit. The resilient unit is preferably located between the outer portions.

The one or more outer portions may be attached to the resilient core by one or more of tags, adhesive, sewing and/or welding.

The one or more outer portions may be attached to the resilient core at a plurality of attachment locations, which attachment locations are preferably spaced from the perimeter region.

The first and second outer portions may be joined together by tags, tufts, welds, sewing and/or adhesive.

The first and second outer portions preferably both comprise spacer material.

Preferably the resilient core comprises a plurality of resilient elements encapsulated within pocketing material, more preferably between sheets or leaves of pocketing material. More preferably the resilient elements comprise coil springs.

Preferably, one or more of the outer portions are attached to one or more of the sheets of the core.

In a preferred arrangement, one or both of the first and second outer portions are joined to the resilient core by joining the inner layer of the outer portion to a sheet of the pocketing material of the core. Where both outer portions are joined to the resilient core, preferably the inner layer of each of the outer portions is joined to a respective, separate sheet of the pocketing material.

The outer portions may be substantially alike. Alternatively, the outer portions may differ from one another in one or more characteristics, including (but not limited to): thickness, knit density, material composition, air permeability, thermal insulation. The outer and inner layers of the at least one outer portion may be substantially alike. Alternatively, the outer and inner layers of the at least one outer portion may differ from one another in one or more characteristics, including (but not limited to): thickness, knit density, material composition, permeability, thermal insulation.

According to another aspect of the present invention there is provided a method of making a resilient unit comprising at least one outer portion, and a resilient core, wherein the outer portion comprises a spacer material including inner and outer layers linked by connecting pile threads, wherein the method comprises attaching the outer portion to the resilient core.

The method may comprise attaching the one or more outer portions to the resilient core by one or more of tags, tufts adhesive, sewing and welding.

The method may include attaching the one or more outer portions to the resilient core at a plurality of attachment locations, which attachment locations are preferably spaced from the perimeter region.

The method may comprise joining together the first and second outer portions by tags, tufts welds, sewing or adhesive.

In a preferred arrangement, the method comprises attaching one or more of the outer portions to one or more of the sheets of pocketing material of the core.

The method may comprise joining the outer portion to the resilient core by joining the inner layer of the outer portion to a sheet of pocketing material of the core.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

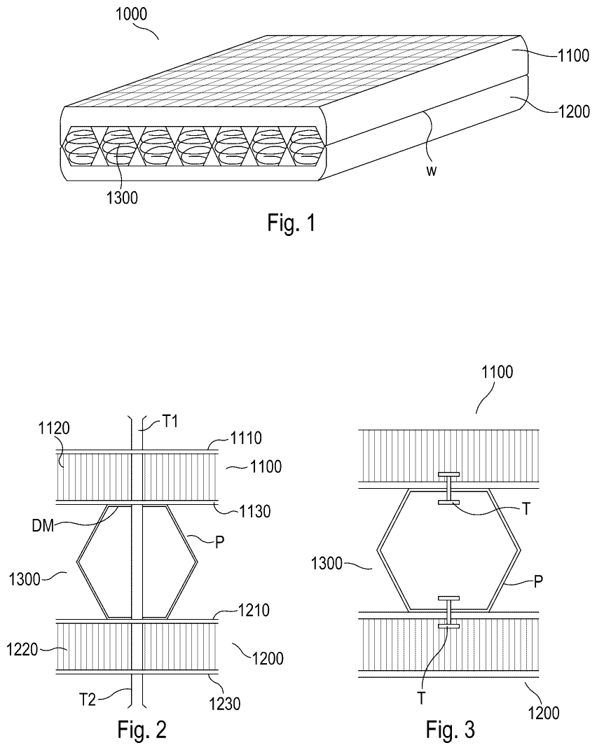

FIG. 1 shows schematically a resilient unit according to an embodiment of the present invention;

FIG. 2 is a schematic detailed view of a part of the unit of FIG. 1;

FIG. 3 is a schematic detailed view of a part of the unit of FIG. 1 according to an alternative embodiment; and

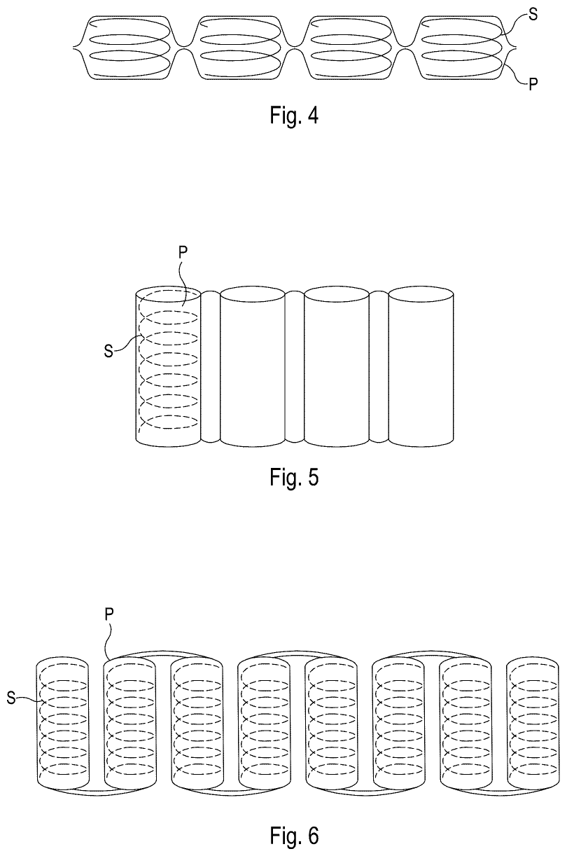

FIGS. 4-6 are schematic views of examples of alternative types of resilient core for use with the unit of FIGS. 1-3.

Turning to FIG. 1, this shows generally at 1000, in part cutaway, a resilient unit according to an embodiment of the present invention. FIG. 1 is a schematic representation of the resilient unit, which is typically for use as a stand-alone item, such as a cushion, pad or mattress topper for example, or in an upholstered article, such as a mattress or seat base (not shown). The resilient unit of the present invention makes use of so-called spacer fabric, as sold by Muller Textile under the trade mark 3 Mesh®.

Spacer fabric typically comprises two knitted layers that are connected and kept apart by spacer—or “connecting” or “pile”—threads.

In FIG. 1, the resilient unit 1000 comprises two outer portions of spacer fabric 1100 and 1200 and a resilient core 1300 therebetween. The resilient core comprises an array of resilient elements which are in this example metallic coil springs S in individual pockets P.

The resilient elements could be of a different type, such as including (but not limited to) non-metallic springs and/or foam components.

The example shown contains only a small number of resilient elements side by side. In reality the number could be much greater, depending on the application. Also, only a single row of resilient elements is shown in the drawing, whereas in reality the core would feature several rows of resilient elements.

The portions 1100 and 1200 of spacer fabric are joined together along the edges of the unit 1000, for example by ultrasonic welding at W, though other methods of joining the portions 1100 and 1200 could be employed.

Within the unit, one or both of the spacer fabric portions are joined to the resilient core, as will be described below. FIG. 2 shows schematically a detailed view of how a connection is made between the spacer fabric and the resilient core. The spring is omitted in the interests of clarity. In this example, only the upper portion 1100 of spacer fabric is joined to the core 1300. The drawing shows a single connection being made.

A first ultrasonic welding tool T1 is inserted through the open knit of an upper surface 1110 of the fabric portion 1100, then through connecting threads 1120 of the fabric portion 1100 as far as a lower surface 1130 of the fabric portion 1100. There it meets a second ultrasonic welding tool T2 which has been inserted through the open knit of a lower surface 1230 of the fabric portion 1200, through connecting threads 1220 and through the open knit of upper surface 1210 of fabric portion 1200, then through a lower portion of pocketing material PM of the resilient core 1300. When the two tools T1 and T2 are pressed together and an ultrasound signal is passed between them, localised heating occurs in the pocketing material PM and the lower surface 1130 of the spacer fabric, causing them to fuse or weld together.

The insertion of the tools through the open knit of the spacer fabric does not damage or disturb the fabric because of its open structure, and the attachment of its lower or inner surface only, to the resilient core, means that from the exterior there are no visible signs of the connection, which makes for an aesthetically pleasing, uninterrupted outer surface. Only one of the spacer fabric portions may be connected to just one side of the resilient core, as shown in FIG. 2, or else both portions of spacer fabric may be joined to the core. In an example not shown, the lower portion is also joined, this time to the lower portion of pocketing material PM, in a similar way.

Ultrasonic welding is not the only means of attaching the spacer fabric to the resilient core. FIG. 3 shows an alternative arrangement in which the lower surface of the upper portion of spacer fabric has been attached to the pocketing material of the core by a tag T, such as a barbed-type tag of recyclable plastics. In this example, the lower portion of spacer fabric has also been attached to the pocketing material by a second tag T.

In a further alternative, or in addition, adhesive may be applied to the inner layer of spacer fabric and/or to the pocketing material to effect a connection (example not shown).

As an alternative, or in addition, portions of the spacer material/fabric may be attached to the core (e.g., pocketing material of the core) and/or to one another by sewing. An example would be the use of an overlocking stitch, for example around a periphery of the core.

As a further alternative, or in addition, one or more threads, for example polyester threads, may be used to connect the spacer fabric to the core (for example to pocketing material of the core), for example in a region spaced from a periphery thereof.

The example of resilient core given in FIGS. 1-3 has a plurality of coil springs S located between axially superposed sheets of polyester pocketing material that are joined at locations between the springs (to form the pockets P) and along the edges of the unit, typically by ultrasonic welding. An example of such a unit, and a description of how it is made, may be found for example in our published UK patent number GB 2426926 B. FIG. 4 shows in schematic end view an example of this type of resilient core.

However, other types of resilient core may also be used in this invention, including (but not limited to) the examples shown in FIGS. 5 and 6.

FIG. 5 shows schematically a plurality of coil springs S in individual pockets P formed by folding a sheet of pocketing material over the springs and then joining the leaves of the pocketing material at positions between the springs and along the edges to encapsulate the springs.

FIG. 6 shows a further alternative type of pocketed spring unit in which the springs S are located in pockets P that have then been fan-folded using the pocketing material between adjacent springs as hinges, as described in our UK patent number GB 2547336 B.

Resilient units made in accordance with the present invention may have a variety of uses, including (but not limited to): in upholstered articles, such as mattresses and seat pads/bases, or as stand-alone articles such as mattress toppers and cushions. The spacer material contributes to the resilience of the unit, whilst providing insulation and also allowing air to circulate throughout the unit.

The surface layers of the spacer material can have a range of thicknesses and of mesh sizes, ie the knit can range in size, and the fabric can have a different mesh size on opposite sides. The spacer fabric, and in particular its mesh size and thickness can be the same on both sides of the resilient unit, or else the two sides can have different spacer fabrics, selected for their characteristics, such as thickness, air permeability, insulating qualities (or others) according to the requirements of the article.

Whilst the example shown is of two outer portions of spacer fabric material enveloping the resilient core, the outer fabric could alternatively comprise a substantially continuous portion extending around the core, where necessary joined to itself at a perimeter region.

In addition, whilst the examples illustrate the spacer fabric being joined to the pocketing material at an axial end of a spring, it could alternatively, or in addition, be joined to surplus pocketing material beside a spring, or between adjacent springs.

Embodiments of the present invention provide a resilient unit in which a portion of spacer material lies over or beneath (or both over and beneath) a resilient core, for example comprising an array of pocketed springs. The spacer material is joined to the resilient core by one or more means, as described above. In some embodiments, the core may be sandwiched between two portions of spacer material that are joined to the core and/or to each other, where appropriately through the core and/or around its periphery.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A resilient unit comprising at least one outer portion, and a resilient core, wherein the outer portion comprises a spacer material including inner and outer layers linked by connecting threads, and wherein the outer portion is attached to the resilient core.

2. A unit according to claim 1, wherein the outer portion is arranged to extend around the core and comprises edges that are joined together at a perimeter region of the unit.

3. A unit according to claim 1 wherein the outer portion comprises first and second outer portions joined at least at a perimeter region of the unit.

4. A unit according to claim 1, wherein the one or more outer portions are attached to the resilient core by one or more of tags, tufts, adhesive, sewing and/or welding.

5. A unit according to claim 1, wherein the one or more outer portions are attached to the resilient core at a plurality of attachment locations, at least some of which attachment locations are spaced from the perimeter region.

6. A unit according to claim 3, wherein the first and second outer portions are joined together by tags, tufts, welds, sewing or adhesive.

7. A unit according to claim 1, wherein the resilient core comprises a plurality of resilient elements encapsulated within pocketing material.

8. A unit according to claim 7, wherein the outer portion is attached to a sheet of pocketing material of the core.

9. A unit according to claim 7 wherein the outer portion is joined to the resilient core by joining the inner layer of the outer portion to a sheet of the pocketing material of the core.

10. A method of making a resilient unit comprising at least one outer portion, and a resilient core, wherein the outer portion comprises a spacer material including inner and outer layers linked by connecting threads, wherein the method comprises attaching the outer portion to the resilient core.

11. A method according to claim 10, wherein the method comprises attaching the one or more outer portions to the resilient core by one or more of tags, tufts, sewing, adhesive and/or welding.

12. A method according to claim 10, wherein the method includes attaching the outer portion to the resilient core at a plurality of attachment locations, at least some of which attachment locations are spaced from the perimeter region.

13. A method according to claim 10, wherein the method comprises attaching the outer portion to one or more of the sheets of pocketing material of the core.

14. A method according to claim 13, wherein the method comprises joining the outer portion to the resilient core by joining the inner layer of the outer portion to a sheet of pocketing material of the core.
